(19) United States
(12) Patent Application Publication
(10) Pub. No.: US 2026/0166927 A1
(43) Pub. Date: Jun. 18, 2026

(54) SYSTEM AND METHOD FOR ON-VEHICLE BONDED BEACON SENSORS

(71) Applicant: AKTV8 LLC, Wixom, MI (US)

(72) Inventors: Joshua D. Coombs, Wixom, MI (US); Jake Dunda, Brighton, MI (US)

(21) Appl. No.: 19/423,946

(22) Filed: Dec. 17, 2025

Related U.S. Application Data
(60) Provisional application No. 63/735,337, filed on Dec. 18, 2024.
(60) Provisional application No. 63/800,433, filed on May 5, 2025.

(51) Int. Cl. B60C 23/04; B60C 23/00; B60P 7/08

(52) U.S. Cl. CPC B60C 23/0464; B60C 23/007; B60C 23/009; B60C 23/0415; B60C 23/0457; B60C 23/0471; B60C 23/0488; B60P 7/0861; B60Y 2200/145

(57) ABSTRACT

A wireless sensor system for a vehicle includes: a given wireless sensor configured to monitor a corresponding physical parameter. The wireless sensor system also includes a mobile device configured to communicate bidirectionally with the given wireless sensor for setting configuration data of the given wireless sensor. The mobile device is further configured to cause the given wireless sensor to operate in a 1-way communication mode and to periodically transmit sensor data regarding the corresponding physical parameter. A method of configuring a wireless sensor system for a vehicle comprises: sensing, by a mobile device, a new wireless sensor; and transmitting, by the mobile device, configuration data to the new wireless sensor. wherein the configuration data causes the new wireless sensor to operate in a 1-way communication mode and to transmit sensor data to a gateway.

### CROSS REFERENCE TO RELATED APPLICATIONS

This utility patent application claims the benefit of and U.S. Provisional Patent Application No. 63/735,337, filed Dec. 18, 2024, and U.S. Provisional Patent Application No. 63/800,433, filed May 5, 2025, the contents of which are incorporated herein by reference in their entirety.

### BACKGROUND OF THE INVENTION

### 1. Field of the Invention

The present invention relates to a system for configuring and using a plurality of sensors on a vehicle for wireless communications.

### Background

Vehicles, such as semi-trucks and trailers, may use numerous sensors that communicate wirelessly to transmit information. Such sensors may measure various parameters, such as measure tire pressure, suspension pressure/load, hub temperature, etc. The sensors may use Bluetooth (BT) wireless communications protocols and may be configured as “Beacons” that broadcast signals in a 1-way transmission. A fully loaded truck and trailer may have 80 to 100 sensors on board, all over the vehicle. For example, a flatbed trailer configured to haul rolls of steel may have 32 tires, 16 hubs, 8 brakes, 3 lift axles, a primary suspension, and ten (10) rigging sensors, for a total of seventy (70) wireless sensors on the trailer alone. Each sensor may send BT transmissions that needs to be “read” by a receiver, such as a mobile device, a BT Repeater and/or a Gateway. Sensors that are far away from a receiver more trouble being received. With up to 100 sensors competing for wireless connection a receiver, there is high risk for signal collision that can cause failed communications—some sensors may never be able to connect. For a mobile device to read all these sensors, a BT receiver in the mobile device may be required to be operated at a maximum scanning frequency—this can be resource intensive, taking processing speed and quickly depleting a battery of the mobile device. Additionally, there may be range limitations for wireless transmission by sensors on a vehicle. BT sensors may have a maximum range of about 20 feet. Sensors placed farther from the receiver may have unreliable communications.

Conventional wireless transmitters for on-vehicle sensors are configured from the factory for a given sensing application and for numerous data communications settings, such as frequency of data reporting and transmission power output.

Furthermore, some high-traffic locations, such as distribution sensors or depots, may be especially challenging for wireless sensor applications. A distribution sensor or depot may have a large concentration of a hundred or more vehicles, with a large amount of BT and WiFi data communication. On-vehicle wireless sensing systems should be robust in such high-traffic locations.

### SUMMARY

The present disclosure provides a wireless sensor (WS) system for a vehicle. The WS system includes a given wireless sensor configured to monitor a corresponding physical parameter. The WS system also includes a mobile device (MD) configured to communicate bidirectionally with the given wireless sensor for setting configuration data of the given wireless sensor. The mobile device is further configured to cause the given wireless sensor to operate in a 1-way communication mode and to periodically transmit sensor data regarding the corresponding physical parameter.

In some embodiments, the WS system further includes a gateway configured to receive the sensor data from a plurality of wireless sensors including the given wireless sensor. In some embodiments, the gateway is configured to relay the sensor data from the plurality of wireless sensors to the mobile device. In some embodiments, the gateway further includes at least one of a radio modem or cellular data radio, and which is configured to transmit the sensor data from the plurality of wireless sensors to a remote computer. In some embodiments, the WS system further includes a second gateway, and the gateway is configured to transmit the sensor data from the plurality of wireless sensors to the second gateway. In some embodiments, the WS system further includes a sensor integrated with the gateway and configured to detect proximity to a magnet or metallic structure relative thereto. In some embodiments, the WS system further includes a proximity sensor in functional communication with the gateway and configured to detect a position of at least one of: a brake actuator, a cargo rigging device, a landing gear, a bogie slider, a fifth wheel lock, or a deployable aerodynamic surface. In some embodiments, the given wireless sensor includes a tire pressure monitoring sensor (TPMS). In some embodiments, the given wireless sensor includes at least one of: a suspension air pressure sensor, a hub temperature sensor, a hub vibration sensor, a strap tension monitoring sensor, a door position sensor, or a proximity sensor. In some embodiments, the given wireless sensor includes a temperature sensor configured to sense temperature of cargo. In some embodiments, the given wireless sensor includes one or more accelerometers configured to detect a tension of a rigging device for securing cargo. In some embodiments, the configuration data includes a timing period or a timing window for transmitting the sensor data. In some embodiments, the configuration data includes a power setting for transmitting the sensor data.

The present disclosure also provides a method of configuring a wireless sensor system for a vehicle. The method comprises: sensing, by a mobile device, a new wireless sensor; and transmitting, by the mobile device, configuration data to the new wireless sensor. The configuration data causes the new wireless sensor to operate in a 1-way communication mode and to transmit sensor data to a gateway.

In some embodiments, sensing the new wireless sensor includes optically reading a quick response (QR) code attached to the new wireless sensor. In some embodiments, the method further includes prompting, by a user interface of the mobile device, for an operator to designate a location on the vehicle for the new wireless sensor. For example, the location of the new wireless sensor may include a particular tire of the vehicle. In some embodiments, the configuration data includes at least one of: a timing period for transmitting the sensor data, a timing window for transmitting the sensor data, or a power setting for transmitting the sensor data. In some embodiments, the configuration data includes a first timing period for transmitting the sensor data, and a second timing period for transmitting alert messages, wherein the second timing period is substantially shorter than the first timing period.

The present disclosure also provides a wireless sensor (WS) system for a truck and trailer. The system includes: a telemetry device, a first plurality of wireless sensors and a first gateway each located on the truck. The first plurality of wireless sensors are each configured to monitor a corresponding first physical parameter and to transmit a first sensor data regarding the corresponding first physical parameter, wherein the first gateway is configured to receive the first sensor data from the first plurality of wireless sensors and to relay the first sensor data to the telemetry device for transmission to a remote computer away from the truck and trailer. The system also includes a second plurality of wireless sensors and a second gateway electronic module each located on the trailer. The second plurality of wireless sensors are each configured to monitor a corresponding second physical parameter and to transmit a second sensor data regarding the corresponding second physical parameter, wherein the second gateway is configured to receive second sensor data from the second plurality of wireless sensors and to relay the second sensor data to the first gateway. The first gateway is further configured to receive the second sensor data from the second gateway and to relay the second sensor data to the telemetry device for transmission to the remote computer.

In some embodiments, at least one wireless sensor of the first plurality of wireless sensors is configured to measure a first acceleration of at least one wheel of the truck, at least one wireless sensor of the second plurality of wireless sensors is configured to measure a second acceleration of at least one wheel of the trailer, at least one of the first gateway or the second gateway is configured to compare data regarding the first acceleration with data regarding the second acceleration to confirm that the trailer is coupled to the truck to move together, and the at least one of the first gateway or the second gateway is configured to confirm a bonding or pairing between the first gateway and the second gateway based on the confirmation that the trailer is coupled to the truck to move together.

In some embodiments, the first gateway includes a first accelerometer configured to measure a first acceleration of the truck, the second gateway includes a second accelerometer configured to measure a second acceleration of the trailer, at least one of the first gateway or the second gateway is configured to compare data regarding the first acceleration with data regarding the second acceleration to confirm that the trailer is coupled to the truck to move together, and the at least one of the first gateway or the second gateway is configured to confirm the bonding or pairing between the first gateway and the second gateway based on the confirmation that the trailer is coupled to the truck to move together.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings.

FIG. 1 shows a schematic block diagram of a wireless sensor (WS) system for a truck and trailer, in accordance with aspects of the present disclosure.

FIG. 2 shows a schematic block diagram of a wireless sensor (WS) system for a vehicle, in accordance with aspects of the present disclosure.

FIG. 3 shows a schematic block diagram of another wireless sensor (WS) system for a vehicle, in accordance with aspects of the present disclosure.

FIG. 4 shows an exploded view of an integrated air control module, in accordance with aspects of the present disclosure.

FIG. 5 shows a cutaway view of a manifold of the integrated air control module of FIG. 4.

FIG. 6 presents a schematic diagram of a semi-tractor and trailer, showing additional sensors monitored by a system, in accordance with aspects of the present disclosure.

FIG. 7 shows a flow diagram illustrating steps in a method for configuring and operating a wireless sensor (WS) system for a vehicle, in accordance with aspects of the present disclosure.

FIG. 8 shows a schematic block diagram of another wireless sensor (WS) system for a truck and several different trailers, in accordance with aspects of the present disclosure.

FIGS. 9A-9B show an assembly for monitoring a position of a pneumatic brake actuator between retracted and extended positions, respectively, in accordance with aspects of the present disclosure.

FIG. 10 shows a timing diagram for wireless sensor (WS) system, in accordance with aspects of the present disclosure.

### DESCRIPTION OF THE ENABLING EMBODIMENTS

Referring to the drawings, the present invention will be described in detail in view of following embodiments.

The present disclosure provides opportunities for improved assignment and configuration of wireless sensors for on-vehicle or complex multi-sensor applications. A system may include wireless sensors with multiple different software configurations. For example, wireless transmitters may be configured as tire pressure monitoring sensors (TPMS), suspension pressure monitoring sensors (SPMS), which may measure load, and iPlug sensors for monitoring hub or differential temperature and vibration. Each of these sensors may be set to transmit periodic data at different time intervals, with different sampling and processing parameters. It would be advantageous to be able to change parameters of these wireless transmitters, such as the update transmission or sampling timing of the TPMS sensors between different values, such as 30 s to 60, 90 s to provide longer battery life. However, ordering and stocking all these versions is cumbersome.

The present disclosure provides opportunities for additional types of wireless sensors, such as sensors for monitoring strap tension, door position, proximity (prox.) sensor for detecting object presence or placement, temperature for monitoring refrigerated trailer zones from front to back of trailer interior.

According to an aspect of the present disclosure, a single sensor or wireless transmitter device could be provided that is commanded on-vehicle to act as any one of the above or as another type of sensor. A mobile device running a configuration application (App.) may connect to the sensor and issue a functional “assignment”. This has the potential to vastly simplify ordering and stocking, sales and distribution, and customer service/spare sensor stocking. Such configurable wireless sensor may enable “MADE EASY”—installation, operation, support easier.

An issue with conventional wireless sensing includes collisions in which two or more devices simultaneously transmit, preventing receipt of messages. To resolve collisions, sensors may be commanded to transmit in an assigned time window that will not collide with other sensors. This may require changing sensors from one-way transmitting “beacon” type sensors to two-way communication initially to allow sensor timing assignment, then set back into beacon mode—the new Bluetooth 5.4 protocol Periodic Advertising with Response (PAwR) accomplishes this function as well. Another issue involves heavy scanning, in which a device, such as a mobile device, is overloaded in its ability to scan for and receive data from a large number of wireless sensors. The assigned time window allows the mobile device to only “look” for the sensor transmissions at the assigned time, significantly reducing the scanning requirement. Alternatively, the mobile device may be arranged not to scan for each sensor “beacon.” The mobile device may, instead, operate in a bonded or a paired communication state (like BT headphones) to a vehicle-mounted iAir gateway. The gateway receives all the sensor signals and relays them to the mobile device through this bonded or paired connection, significantly reducing the demand/load on the mobile device.

Pairing may refer to negotiating secure wireless communications between devices, including negotiating a security method, exchanging keys, and creating an encrypted session for a current connection. Bonding, on the other hand, may describe a process of storing keys produced during pairing in non-volatile memory on both devices. This allows for future connections to start encrypted and authenticated without needing to repeat the pairing process. A bonded connection may refer to a wireless communications connection using such stored keys.

The present disclosure provides for Sensor assignment: two-way BT communication or bonding/pairing allows the mobile device that is used to setup the sensor (scans the sensor Quick Response (QR) code and assigns the sensor position on vehicle) to send an assignment to the sensor—so a single SKU sensor can be installed it on vehicle in any location, and commanded to function as TPMS, SPMS, iPlug, door switch, strap tension sensor, or as another type of sensor.

The present disclosure provides for improvements in range-similar to assignment above, if a sensor is mounted far away, the system can command it to operate with higher transmit power. If closer, the sensor can be commanded to operate with lower power. However, operating the sensors in constant 2-way communication will deplete batteries and the typical number of bonded or paired connections possible with BT chips may be less than forty, so it may not be possible to bond/pair to all sensors on a vehicle all the time. So a new approach may be needed.

Wireless sensors of the present disclosure may be configured to use Periodic Advertising with Response (PAwR) feature of the BT 5.4 specification in order to improve transmission success. PAwR is commonly used in electronic shelf labels, to enable hundreds of BT labels in a store. PAwR may be implemented in on-vehicle wireless transmitters of the sensors, which may still be operated as a beacon. Additionally or alternatively, the wireless sensors may change timing, such as using random delays, to avoid collisions. The wireless sensors of the present disclosure may employ “adaptive” power management—if not getting through, transmitting power may be increased. If transmissions are always received, transmitting power may be decreased.

The wireless sensors of the present disclosure may use low energy (LE) Coded/Long Range physical layer (PHY) feature of the BT 5.0 and later specification. This feature may increase range by extending transmission. This feature may be combined with PAwR, making the wireless sensors of the present disclosure be “adaptive”. In some cases, the wireless sensors may recognize a sensor that is not successfully being received, and then increase sensor transmit power to improve success.

The present disclosure provides a bonded/paired beacon concept for a system that has several objectives. Objectives include: reducing sensor BT communication collision risk by assigning transmission timing to each sensor on a vehicle; reducing mobile device+App scanning overhead by only maintaining a bond or pairing to Gateway (instead of trying to receive all sensors independently); and minimizing sensor SKUs: with assigning functionality, no need to sell+inventory sensors of each type (TPMS, SPMS, iPlug, Door, Temp etc.)—only need Cap or Thru SKUs. The bonded/paired beacon concept for a system may include initializing sensors and gateway devices for a given vehicle.

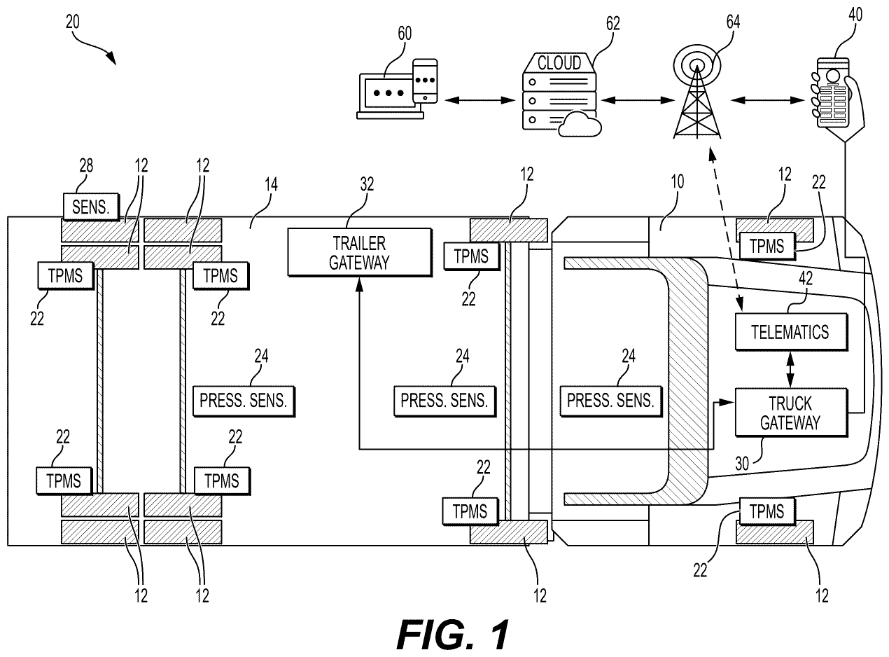

FIG. 1 shows a schematic block diagram of a wireless sensor (WS) system 20 for a truck 10 and trailer 14, in accordance with aspects of the present disclosure. The truck 10 may also be called a tractor and may be coupled to several different trailers 14, including one or more trailers 14 at any given time. The truck 10 and the trailer 14 each have a plurality of tires 12. The WS system 20 includes a tire pressure monitoring sensor 22 attached to each of the tires 12 for monitoring air pressure therein. The WS system 20 also includes suspension pressure monitoring sensors 24 configured to monitor air pressure in one or more suspension components, such as air springs.

The WS system 20 includes a truck gateway 30 that is located in the truck 10 and configured to receive signals from the tire pressure monitoring sensors 22 and from the suspension pressure monitoring sensors 24 in the truck 10. The WS system 20 also includes a trailer gateway 32 located in the trailer 14 and configured to receive signals from the tire pressure monitoring sensors 22 and from the suspension pressure monitoring sensors 24 in the trailer 14. Either or both of the truck gateway 30 and/or the trailer gateway 32 may be integral with an electrical control unit (ECU) of an air control module having one or more valves for controlling distribution of pressurized air. Alternatively, if sensors have adequate range a gateway may not be needed, and the mobile device may be able to receive sensor transmissions directly.

The trailer gateway 32 may be configured to forward data to the truck gateway 30 regarding the sensor data received from the tire pressure monitoring sensors 22 and from the suspension pressure monitoring sensors 24 in the trailer 14.

The WS system 20 shown in FIG. 1 also includes a mobile device 40, such as a smartphone or a tablet, and which runs a mobile application, also called a mobile App. The WS system 20 shown in FIG. 1 also includes a telemetry device 42 configured to communicate data with a remote computer 60 via a data network 62. The remote computer 60 may include one or more physical and/or virtualized computer devices, such as servers. However, the remote computer 60 may take other forms, such as a distributed network of computing and/or data storage resources. The data network 62 may include the internet and/or one or more private networks, such as local area networks, wide area networks (WAN), and/or a cellular data network. The telemetry device 42 may include a cellular data modem and/or another type of radio interface to communicate with a fixed base station antenna 64. Alternatively a mobile device may not be used and the WS data may be received and sent directly though telemetry device.

The telemetry device 42 may include, for example, a GeoTab device or a Samsara device. The telemetry device 42 may receive and re-transmit the sensor data received from the tire pressure monitoring sensors 22 and from the suspension pressure monitoring sensors 24 in both the truck 10 and the trailer 14. All of such data may be collected and stored by the remote computer 60. The remote computer 60 may include one or more physical processors and/or storage devices.

Additionally or alternatively, the mobile App. may be configured to cause the mobile device 40 to transmit sensor data to the remote computer 60 using a cellular data modem that is integrated in the mobile device 40.

In an alternative configuration, the WS system 20 may not include a telemetry device 42. Instead, a radio modem or cellular data radio may be integral with the truck gateway 30 and/or the trailer gateway 32. This may be especially advantageous for operators that do not wish to provide drivers with mobile devices or for driverless (e.g. autonomous) vehicles.

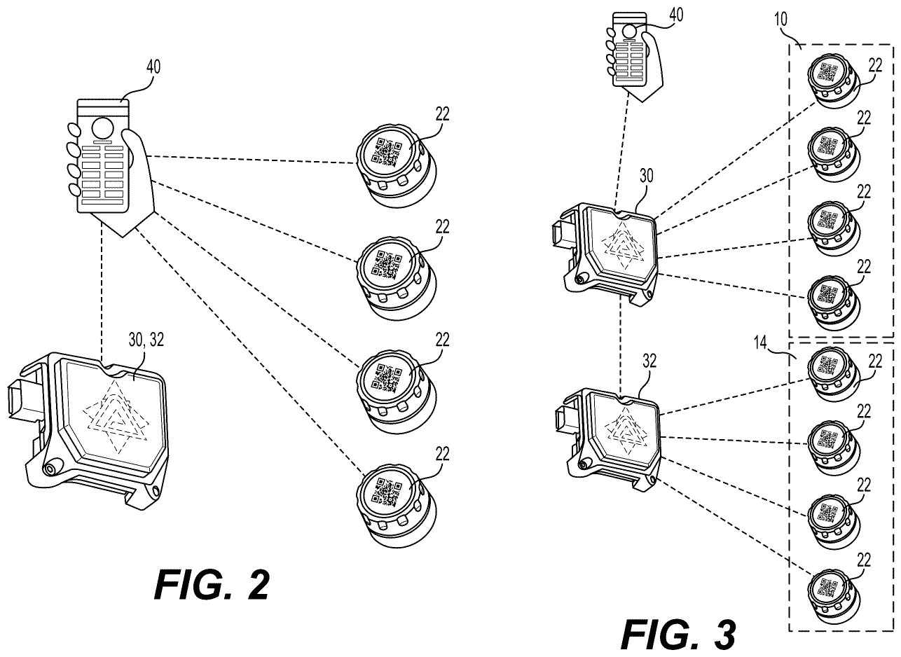

FIG. 2 shows a schematic block diagram showing initialization of a wireless sensor (WS) system for a vehicle, in accordance with aspects of the present disclosure. During the initialization phase, as shown on FIG. 2, an application (App.) running on a mobile device 40 bonds or pairs to each sensor 22 upon installation to command function and timing, then sets the sensor 22 to be a beacon. The app. on the mobile device 40 also bonds or pairs to one or more of the gateways 30, 32. Once the sensors 22 are confirmed, the app. assigns them to a corresponding gateway of the one or more gateways 30, 32. The app. may also assign vehicle-specific information to the truck gateway 30 and/or the trailer gateway 32. If vehicle is defined as trailer, the mobile device 40 may disconnect. A truck gateway 30 may be configured to look for trailer gateways 32 and will notify the Mobile App. if other trailers are seen. A driver/user can select which Trailer they are hitching to.

FIG. 3 shows a schematic block diagram showing operating a wireless sensor (WS) system for a vehicle, in accordance with aspects of the present disclosure. During the operational phase, the app. on the mobile device 40 may stay paired to the truck gateway 30, receiving sensor info through the truck gateway 30. New users can pair to the truck gateway 30 to access vehicle info. If a trailer is assigned in app., the truck gateway 30 bonds or pairs with the trailer gateway 32 and routes trailer data, such as monitored pressures of the tires of the trailer 14, through to the app. on the mobile device 40.

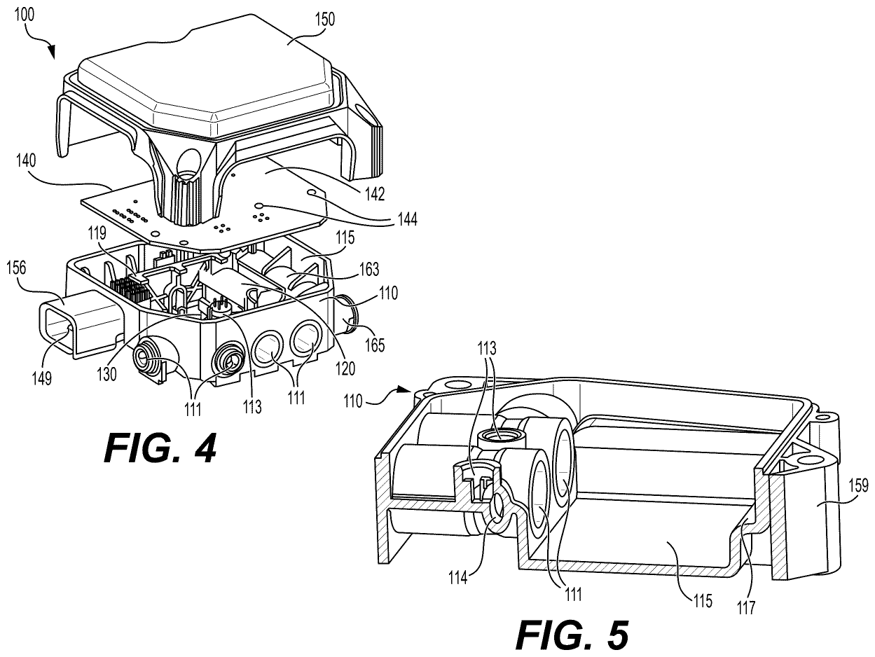

FIG. 4 shows an exploded view of an integrated air control module 100, in accordance with aspects of the present disclosure. The air control module 100 may be configured to control air flow to one or more different devices, such as air springs, air-controlled actuators, such as actuators for selectively lifting or deploying a liftable axle, tire inflation, etc. In some embodiments, one or more of the truck gateway 30 and/or the trailer gateway 32 may be implemented by hardware and/or software of an air control module 100. FIG. 5 shows a cutaway view of a manifold 110 of the integrated air control module 100 of FIG. 4.

As shown in FIGS. 4-5, the air control module 100 includes: a manifold 110, defining three ports 111; a channel 114; a cavity 115; and a pressure sensor port 113. The air control module 100 can additionally include an actuator 120, a pressure sensor 130 arranged within the pressure sensor port 113, an electronics module 140, an integrated filter, and/or any other suitable component. The air control module 100 may be assembled into a self-contained unit, as shown by example in FIG. 4, but can alternatively be configured in any other suitable manner.

The electronics module 140 includes an electronics substrate 142, such as a printed circuit board (PCB) and which is arranged to enclose the actuator 120 and pressure sensor 130 within the manifold 110. The air control module 100 also includes a cover 150 coupled to the manifold 110 and cooperatively enclosing the actuator 120, the pressure sensor 130, and the electronics module 140. The electronics module 140 may also include an input/output module and/or a processor (not shown), and an external connector 149. The electronics module can output data and communicate bi-directionally via Bluetooth or CAN, or any other suitable communication standard. The output can also include external diagnostics LED control, to allow users to install an LED indicator on the vehicle that can communicate diagnostics information.

The electronics module 140 also includes a displacement sensor 144 that functions to detect and report a displacement measurement. A displacement measurement preferably includes a measurement of the relative distance or movement between the air control module 100 and a portion of a vehicle, such as the truck 10, but can additionally or alternatively include an absolute distance measurement, a motion measurement, a proximity detection, or any other suitable measurement. For example, the displacement sensor 144 can detect a position of an air-controlled actuator or other structure and transmit a quantitative representation of the detected position. The displacement sensor 144 may include an array of Hall-effect sensors that is configured to sense the relative displacement of a magnet 220, coupled to the object or structure to be sensed. The displacement sensor 144 can alternatively be any form of non-contact displacement sensor. As a further alternative, the displacement sensor 144 can be any suitable sensor capable of detecting the movement and/or displacement of the air control module 100. The displacement sensor 144 is preferably arranged along a broad face of the electronics substrate 142 opposing (e.g., distal) the manifolds and/or actuators, but can alternatively be arranged along the broad face proximal the manifolds and/or actuators, be arranged on the manifold, or be arranged in any other suitable location. The electronics module 140 can include one displacement sensor 144 per strut; one displacement sensor 144 per manifold; one displacement sensor 144 per actuator; multiple displacement sensors 144 per strut, manifold, or actuator; one displacement sensor 144 for multiple struts, manifolds, or actuators; or include any suitable number of displacement sensor 144 configured to couple to and/or monitor any other suitable system component. However, the electronics module 140 can include and/or be connected to any other suitable set of sensors, including an IMU Inertial Measurement Unit, and the electronics module can be configured to send this data along with the wireless sensor data via BT or CAN.

The manifold 110 defines a connector housing 156 for receiving and retaining an electrical connector to interface with the external connector 149. The manifold 110 defines a manifold retainer 159 for receiving a fastener to secure the manifold 110 to an external structure, such as a structural component of a vehicle. In some embodiments, and as shown in FIG. 5, the air control module 100 can include a filter assembly having an expansion chamber 163, a filter element (not shown), and an exhaust 165.

As shown in FIG. 4, the manifold 110 defines a plurality of ports 111, a pressure sensor port 113, a channel 114, and a cavity 115. The manifold 110 functions to direct fluid flow between one or more inputs and one or more outputs, preferably in cooperation with the actuator(s) 120, but alternatively independently or with any other suitable component. The manifold 110 also functions to contain (e.g., enclose, mechanically protect) system components, such as the actuator(s) 120 and the pressure sensor(s) 130. The manifold 110 can also function as a substrate (e.g., mounting point) for attachment of system components (e.g., the electronics module 140, the cover 150, etc.) or external components. The manifold 110 may be made of a thermoplastic (e.g., nylon or polyvinyl toluene with a 30% glass fill), but can alternatively be made of another synthetic or natural polymer, metal, composite material, or any other suitable material. The manifold 110 may be injection-molded, but can alternatively be milled out of a single block of material (e.g., metal, plastic), cast out of metal, composed of separate sub-components which are fastened together, or made using any combination of these or other suitable manufacturing techniques. The manifold 110 can additionally include a valve retainer 119, which functions to retain the actuators 120 within the cavity 115 and hold them in place. The valve retainer 119 may be molded into the manifold 110, but can alternatively be inserted, fastened, or otherwise coupled to the manifold 110 in any suitable manner. Alternatively, the valve retainer 119 can be omitted entirely.

In some variations, the manifold 110 can include webbing between one or more ports 111, which may be integrally formed with the manifold 110. For example, the ports 111 may be formed, at least in part, during a molding process used to form the manifold 110. As shown in FIG. 5, the cross section of the manifold 110 can also include one or more internal support features 117, such as a ridge along an outer edge of the manifold 110, which can facilitate sealing of the manifold 110 to the cover 150.

The ports 111 may each function to fluidly connect a single attached service to the manifold 110. The ports 111 can also function to receive an external fitting (e.g., a threaded quick-release compressed-gas fitting) that facilitates fluid connection of a port 111 to an attached service. The ports 111 can additionally function to fluidly connect a system inlet (e.g., the filter) to the service, a second service to the service, or provide any other suitable fluid connection between a first and second endpoint. The ports 111 may each define an open first end, open second end, and a flow axis extending between the first and second ends. However, the first end and/or second end can be closed or otherwise configured. The port 111 preferably defines a straight flow axis, but can alternatively define a curved flow path, a branched flow path (e.g., with at least a third end in addition to the first and second end), or any other suitable path along which air can flow through the port 111. In variations including a plurality of ports 111, the flow axis of each port 111 is preferably parallel to each of the other flow axes of each of the other ports 111. In one example, the ports 111 are arranged with the respective flow axes sharing a common plane (port plane). However, multiple ports 111 can be arranged offset from each other, at a non-zero angle to each other, or be arranged in any other suitable configuration.

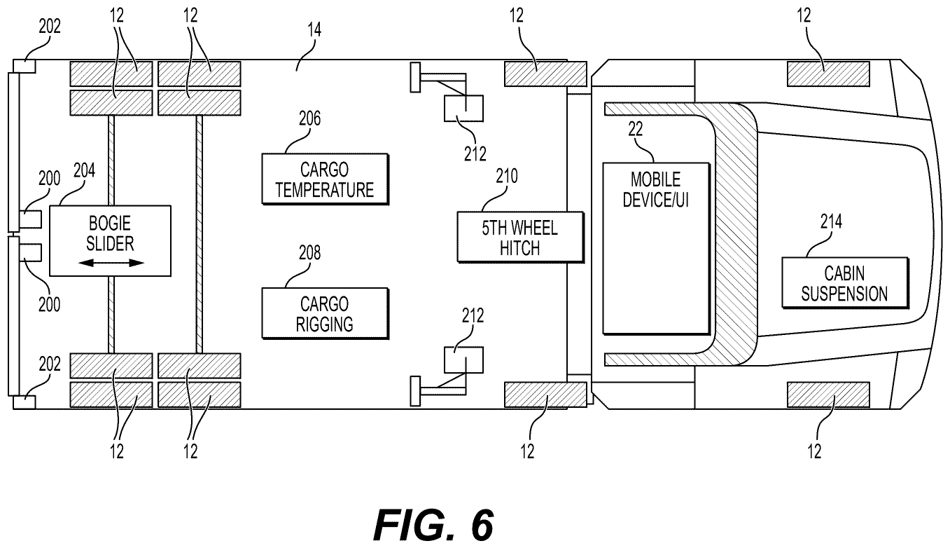

FIG. 6 presents a schematic diagram of a semi-tractor and trailer, showing additional sensors and/or actuators monitored by a system, in accordance with aspects of the present disclosure. The app. on the mobile device 40 can interface with additional sensors and/or actuators to better cover the critical systems on commercial vehicles, such as the tractor/trailer 10, 14 shown, and which include: door sensors 200, light sensors 202, a bogie slider sensor 204, a cargo temperature sensor 206, cargo rigging sensors 208, a hitch controller 210, landing gear actuators 212, and a cab suspension height controller 214. The door sensors 200 may monitor one or more doors to confirm that the doors are closed and/or latched. The light sensors 202 may monitor that one or more brake lights, side-marker lights, and/or turn signal indicator lights are functional. The bogie slider sensor 204 may measure a position of a bogie slider for a slidable axle. Additionally or alternatively, the bogie slider sensor 204 may sense the bogie slider being in a given position or having a latched or locked condition. The cargo temperature sensor 206 may include one or more sensors for monitoring cargo, such as internal spaces of refrigerated trailers. The cargo rigging sensors 208 may measure presence or other features of cargo rigging equipment, such as tension of rigging straps, to confirm that the cargo rigging, such as straps and//or chains) are installed and tight, and that the cargo rigging remains in a given configuration during transport. The hitch controller 210 may monitor and/or control a 5^{th} wheel hitch latch to confirm the truck-to-trailer hitch connection is secure. The landing gear actuators 212 may monitor and/or control retractable landing gear legs to verify that the landing gear legs are retracted prior to driving and/or to confirm that the landing gear legs are locked into a deployed position prior to decoupling the truck from the trailer. The cab suspension height controller 214 may monitor and/or control components of a cab air suspension system.

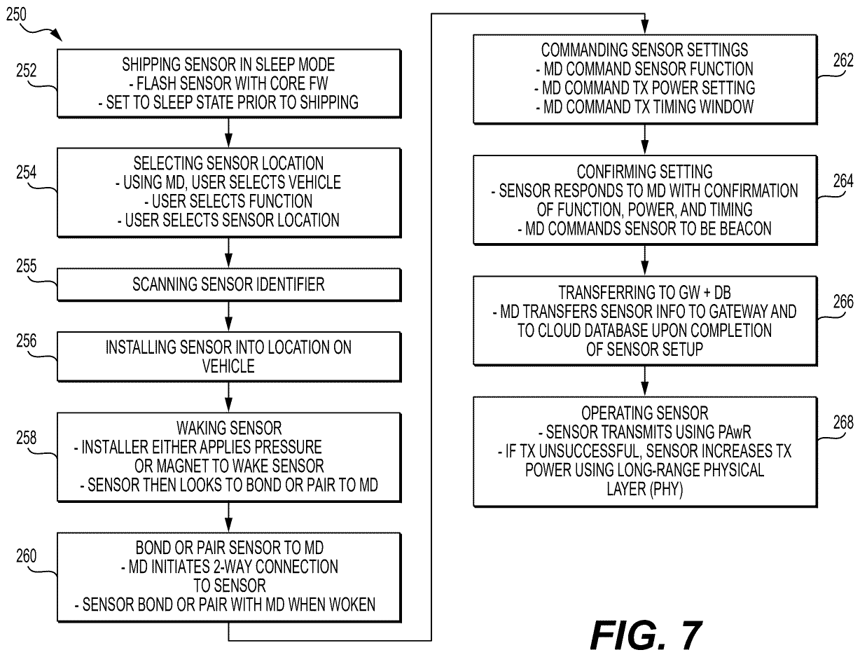

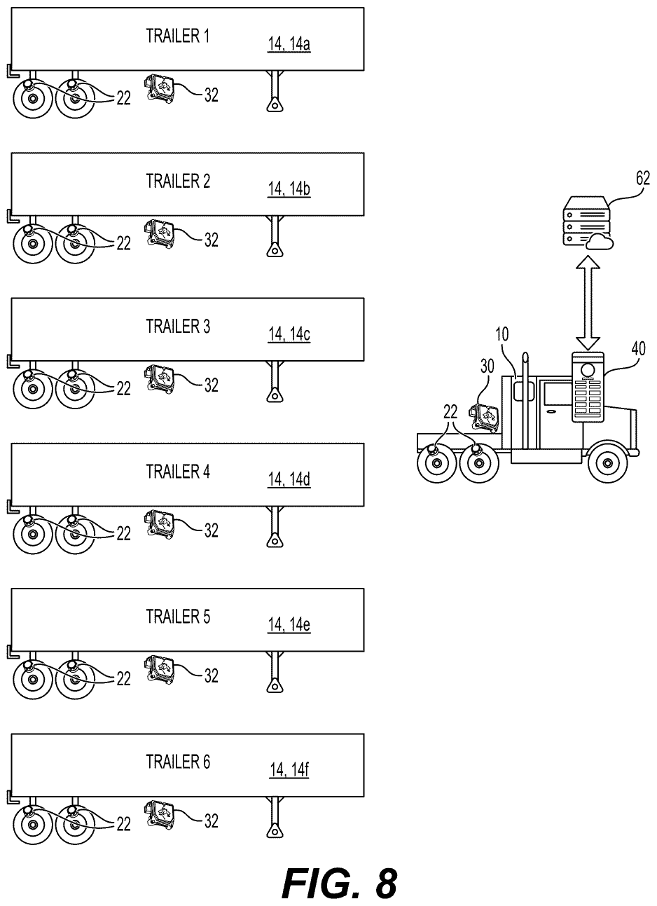

FIG. 7 shows a flow diagram illustrating steps in a method 250 for configuring and operating a wireless sensor (WS) system for a vehicle, in accordance with aspects of the present disclosure. As can be appreciated in light of the disclosure, the order of operation within the method is not limited to the sequential execution as illustrated in FIG. 7, but may be performed in one or more varying orders as applicable and in accordance with the present disclosure.

The method 250 provides a core concept wherein a common sensor part can be assigned to one of a variety of different functions upon installation in a commercial vehicle. This concept may provide ease of use for technician/installers, such as drivers or mechanics to add sensors. A single “portal” can be provided where the drivers and fleet command centers can view the sensor data in a single dashboard. The alternative is to have separate sensors for all functions, where fleets have to order and stock a large number of different part numbers, and different vendors supplying those sensors, where drivers/fleet commands have to toggle between different Apps/dashboards to see the data.

In short, the method 250 includes:
Shipping sensors in sleep state, un-assigned function or transmit;
Upon install, wake and try to bond or pair to a mobile device (MD);
Bond or pair to MD, receive assigned function and transmit window; and
Confirm assignment, disconnect bond or pairing, and operate as assigned in beacon mode.

In some embodiments, the method 250 may also allow the sensors to be re-bonded or re-paired to update or re-assign sensor in future—provides ability to improve the product over time (including cybersecurity updates) and makes it easy for a fleet to re-deploy sensors from a damaged or retired vehicle.

The method 250 includes shipping, at step 252, a sensor in a sleep mode. Step 252 may include flashing the sensor hardware, by a manufacturer or distributor, with a core firmware (FW), and then setting the sensor to sleep prior to shipping.

The method 250 also includes selecting, at step 254, a sensor location of the sensor. Step 254 may include a technician/installer using a mobile device (MD) to select a vehicle, a function of the sensor (such as tire pressure, hub sensor, load sensor, etc.), and a sensor location, such as a particular tire or a particular axle where the sensor is mounted on the vehicle.

The method 250 also includes scanning, at step 255, a sensor identifier using the mobile device MD. The sensor identifier may include a Quick Response (QR) code that may be printed or otherwise affixed to a particular sensor. However, other types of identifiers may be used, such as barcodes or radio-frequency identification (RFID) tags. Alternatively, the user can manually input the sensor identifier into the MD.

The method 250 also includes installing, at step 256, the sensor. Step 256 may include installing the sensor onto the location on the vehicle the corresponds to the sensor location selected at step 254.

The method 250 also includes waking, at step 258, the sensor. Step 258 may include the technician/installer either applying pressure to a pressure transducer of the sensor or applying a magnet near the sensor to cause a magnet-sensitive device, such as a Hall-effect switch in the sensor. The application of pressure or the magnet to the sensor may cause the sensor to exit the sleep mode and to enter an active or woken state.

The method 250 also includes bonding or pairing, at step 260, the sensor to the MD. Step 260 may include the MD initiating 2-way communications with the sensor using Bluetooth or another wireless data transmission protocol and causing the sensor device to be bonded to the mobile device MD. Step 258 may further include the sensor bonding or pairing with the MD to establish the 2-way communications after the sensor is woken at step 258.

The method 250 also includes commanding, at step 262, settings for the sensor. Step 262 may include the MD sending commands to the sensor using Bluetooth or the other wireless data transmission protocol and cause the sensor to have a given configuration. The commands sent at step 262 may include one or more of: a sensor function, (e.g. TPMS, SPMS, iPlug, door sensor, etc.), transmitting power (which may be set based on distance and/or line-of-sight between the sensor and a corresponding gateway), and/or a transmitting timing window. The commands may describe a function of the sensor (e.g. tire pressure monitoring, suspension pressure monitoring, temperature and vibration monitor, door monitoring, etc.). Additionally or alternatively, the commands may set a transmit power for the sensor and/or a transmission timing window, using PAwR or another method. For example, sensors mounted in close proximity to a corresponding gateway 30, 32 may be set with a relatively low transmit power, whereas sensors mounted farther from the corresponding gateway 30, 32 may be set with higher transmit power to ensure reliable communications. Step 262 may include downloading or installing software program components from the mobile device 40 to the sensor to cause the sensor to have a given function. Alternatively or additionally, step 262 may include programming a configuration of the sensor to selectively enable a configuration or portions of pre-existing programming that is resident on in the sensor, such as a firmware program installed at the time of manufacture. By downloading and installing new or revised software programs on the sensor, new functionality can be provided by a sensor, which may include functionality that was not available at the time of manufacture.

The method 250 also includes confirming, at step 264, the settings for the sensor. Step 264 may include the sensor responding to the mobile device MD with to conform receipt and acceptance of the function and/or other settings commanded at step 262.

Additionally, step 264 may include the mobile device MD commanding the sensor to function as a beacon. For example, the MD may command the sensor to function as a beacon (i.e. in a transmit-only mode) upon receipt of the expected confirmation. Functioning as a beacon may include the sensor transmitting data at regular periodic intervals and not to be receptive to changes in configuration. The beacon configuration may include the sensor not to respond to any received transmission. Instead, a sensor with the beacon continuation may be configured only to transmit sensor data in accordance with its particular configuration. Alternatively, the sensor can be receptive to re-connection and 2-way communication with the MD, to allow re-flash or re-assignment.

The method 250 also includes transferring, at step 266, the sensor to the gateway and/or remote server. Step 266 may include the mobile device MD transferring sensor data to the gateway and/or to the remote database so the gateway and/or the remote database have knowledge of the sensor and data expected to be received therefrom. For example, step 266 may include the mobile device sending data to the corresponding gateway 30, 32 to cause the corresponding gateway 30, 32 to receive transmitted information from the sensor. In some embodiments, step 266 may include causing the sensor to be bonded or paired with the corresponding gateway 30, 32.

The method 250 also includes operating, at step 268, the sensor. Step 268 may include the sensor transmitting sensor data, such as measured temperature, pressure, and/or acceleration, to the corresponding gateway 30, 32, and the corresponding gateway 30, 32 receiving and processing the sensor data from the sensor. In some embodiments, step 268 may include transmitting the sensor data using the Periodic Advertising with Response (PAwR) feature of the BT 5.4 specification in order to improve range. In some embodiments, step 268 may include the sensor transmitting data using low energy (LE) Coded/Long Range physical layer (PHY) feature of the BT 5.0 and later specification. In some embodiments, the PHY feature may be used as a fallback in case the PAwR transmission is unsuccessful.

In some embodiments, the sensor may store the location and other settings data in volatile memory. Thus, the location and settings of the sensor can be reset by removing or replacing a battery therein. In such case, the sensor may need to be re-configured or re-programmed using the method 250 upon replacing the battery. This may enable the sensors to be made without non-volatile memory and may provide relative ease in re-using the sensors for different applications. Alternatively, one or more of the sensors may include a non-volatile memory that may not be reset once the configuration is set. In other words, one or more portions of the configuration may only be able to be set once. Other portions of the configuration, such as transmit power, may be able to be set to different values. Alternatively, one or more of the sensors may be reset and reconfigured, but only using a specific command, and which may require a private key. This may limit the usefulness of the sensors for re-use by unauthorized parties that do not possess the specific commands or the private key, making the sensors less likely to be stolen.

FIG. 8 shows a schematic block diagram of another wireless sensor (WS) system for a truck 10 and several different trailers 14a, 14b, 14c, 14d, 14e, 14f, in accordance with aspects of the present disclosure. If the truck gateway 30 that is located in the truck 10 is not bonded or paired to any particular trailer gateway 32, the truck gateway 30 may scan for a new trailer gateway 32. If a trailer gateway 32 is first powered-up, for example, as a result of the corresponding trailer 14 being plugged-in to a corresponding truck 10, the truck gateway 30 may sense the new trailer gateway 32. The truck gateway 30 may cause the mobile device 40, in response to sensing the new trailer gateway 32, to prompt for confirmation that the truck gateway 30 should be bonded or paired to the new trailer gateway 32. This prompting may prevent a truck gateway 30 from accidentally becoming bonded or paired to a nearby trailer gateway 32 that is hitched to a different truck 10. The mobile device 40 may communicate with the remote computer 60 regarding the bonded or paired trailer gateway 32 so the remote computer 60 receives and can record data regarding the hitching of the truck 10 to the given one of the different trailers 14a, 14b, 14c, 14d, 14e, 14f. An option to confirm correct trailer gateway: using the truck and trailer gateway on-board IMU, the gateways can sense matching acceleration of both units and confirm the trailer IMU sees the same acceleration/gyroscopic forces as the truck. Another option is to compare TPMS or Hub sensor accelerometers that are rotating with the wheels between truck and trailer. If the rotational acceleration (rising and falling due to gravity, like an odometer) matches between truck and trailer, confirm and bond or pair the trailer to truck.

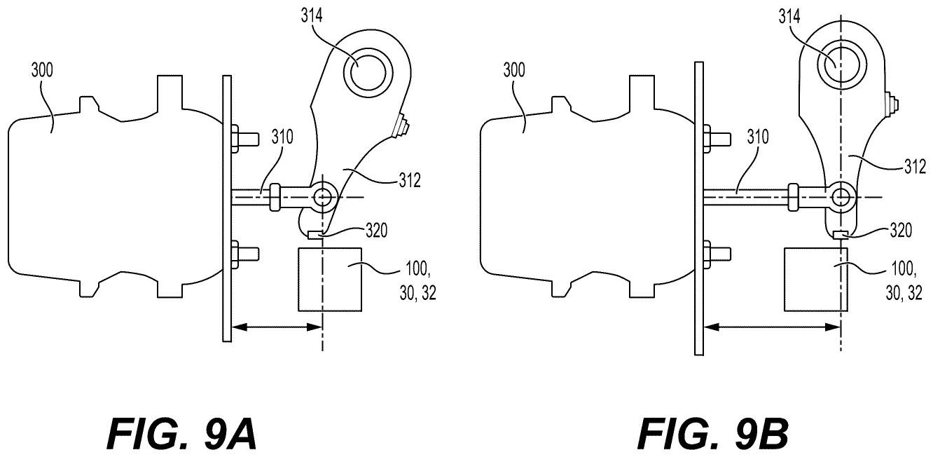

FIGS. 9A-9B show an assembly for monitoring a position of a pneumatic actuator 300 between retracted and extended positions, respectively, in accordance with aspects of the present disclosure. FIG. 9A shows the pneumatic actuator 300 with a rod 310 in a retracted position and FIG. 9B shows the actuator 300 with the rod 310 in an extended position.

As shown, the rod 310 of the actuator 300 attaches to a lever arm 312 in order to rotate a shaft 314 for actuating brakes of a vehicle. A magnet 320 is attached to an end of the lever arm 312 and arranged to be sensed by sensors in the air control module 100. However, the sensors in the air control module 100 may sense a position of the pneumatic actuator 300 in other ways, such as by an optical sensor or by detecting a disturbance in a magnetic or electric field caused by presence or position of a metallic object that is attached to the lever arm 312, or which is a part of the lever arm 312.

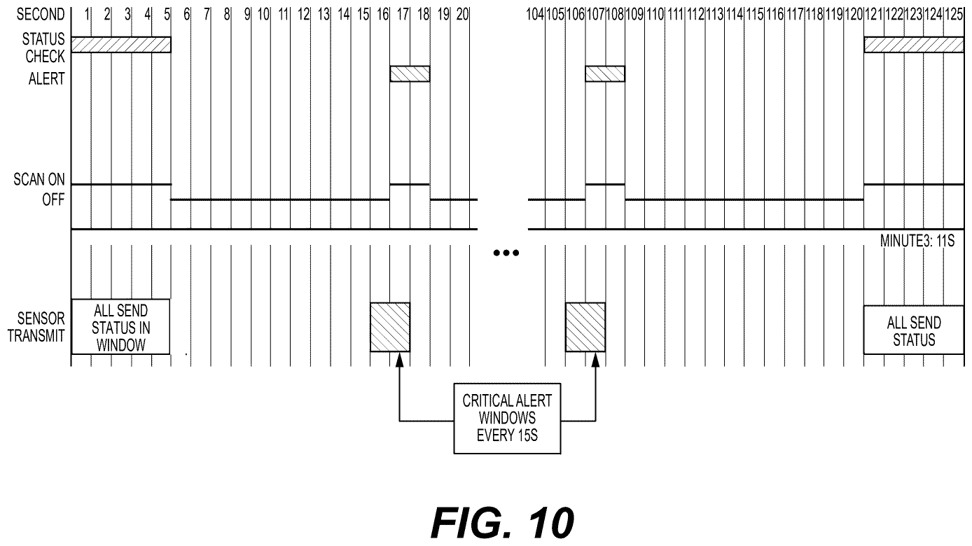

FIG. 10 shows a timing diagram for wireless sensor (WS) system, in accordance with aspects of the present disclosure. In some cases, it may be desirable to reduce a wireless scanning rate of the mobile device 40 in order to improve performance for other tasks and/or to improve battery life. However, operating the mobile device 40 with a longer scanning interval could cause the mobile device 40 to potentially miss sensor transmissions, such as immediate-alert transmissions that come immediately after an event like a tire blow-out. To address this issue, the system may include a sensor transmission window with a new “critical alert” set of windows. The sensors may have two types of transmissions: status and alerts. Status transmissions may occur every 2-minutes, and alert transmissions may occur only when there is an issue to report. All sensors may be assigned a window within the 2-minute status reporting period. Each sensor transmission may take less than 0.05 seconds. All of the sensors may by synchronized to report alerts during a critical-alert window. The critical alert window may have a duration of about 2-seconds and may occur every 15-seconds. However, these are merely examples, and the critical alert windows may have different duration or a different period. By using a periodic critical alert window, the mobile device 40 may be suspended from scanning for a significant amount of seconds per minute, achieving the improvement of MD performance and battery life. As shown on FIG. 10, the mobile device 40 may scan for and receive periodic updates from the gateways 30, 32 and/or individual sensors 22, 24, at 2-minute intervals.

These different timing periods for the status messages and alert messages may be included in the configuration data that is sent to a new wireless sensor. For example, the configuration data may include a first timing period (e.g. the 2-minute interval) for transmitting the sensor data, and a second timing period (e.g. the 15-second interval) for transmitting alert messages.

The present disclosure provides opportunities for improved assignment and configuration of wireless sensors for on-vehicle applications. A system may include wireless sensors with multiple different software configurations. For example, wireless transmitters may be configured as tire pressure monitoring sensors (TPMS), suspension pressure monitoring sensors (SPMS), which may measure load, and iPlug sensors for monitoring other vehicle parameters, such as lift axle deployment. Each of these sensors may be set to transmit periodic data at different time intervals. It may be advantageous to be able to change parameters of these wireless transmitters, such as the update transmission timing of the TPMS sensors between different values, such as 30 s to 60, 90 s to provide longer battery life. However, ordering and stocking all these versions is cumbersome.

The present disclosure provides opportunities for additional types of wireless sensors, such as sensors for monitoring strap tension, a door position, proximity (prox.) sensor for detecting object presence or placement.

According to an aspect of the present disclosure, a single sensor or wireless transmitter device could be provided that is commanded on-vehicle to act as any one of the above or as another type of sensor. A mobile device running a configuration application (App.) may connect to the sensor and issue a functional “assignment”. This has the potential to vastly simplify ordering and stocking, sales and distribution, and customer service/spare sensor stocking. Such configurable wireless sensor may enable “MADE EASY”—installation, operation, support easier.

An issue with conventional wireless sensing includes collisions in which two or more devices simultaneously transmit, preventing receipt of messages. To resolve collisions, sensors may be commanded to transmit in an assigned time window that will not collide with other sensors. This may require changing sensors from one-way transmitting “beacon” type sensors to two-way communication. Another issue involves heavy scanning, in which a device, such as a mobile device, is overloaded in its ability to scan for and receive data from a large number of wireless sensors. To resolve, the mobile device may be arranged not to scan for each sensor “beacon.” The mobile device may, instead, operate in a bonded or a paired communication state (like BT headphones) to a truck-mounted iAir Gateway. The gateway receives all the sensor signals and communicates them to the mobile device thru this bonded or paired connection.

The present disclosure provides for sensor assignment: two-way BT communication or bonding/pairing allows the mobile device that is used to setup the sensor (scans the sensor Quick Response (QR) code and assigns the sensor position on vehicle) to send an assignment to the sensor—so we can use a single SKU sensor, install it on vehicle in any location, and command it to function as TPMS, SPMS, iPlug, door switch, strap tension sensor, or another function and/or sensor type.

In some embodiments, the mobile device 40 may also include a near-field communication (NFC) radio. The NFC radio of the mobile device may be used to scan for radio-frequency identification (RFID) tags on components during a configuration procedure. Scanned RFID tags may provide data, such as a specific brand/model information for tires or other vehicle components, which may be incorporated into the vehicle configuration data. For example, new tires are now being made with RFID chips embedded that include detailed manufacturer information. Adding this info to an installed sensor in the app. may allow fleets to better measure the durability/wear performance of different tire types/manufacturers and may allow a fleet manager to define an optimal tire for their usage/application. RFID tags can be scanned on other components like air springs, shock absorbers, suspension systems, landing gear, etc. so the system can gather more information on the components installed on a vehicle.

Over time, and with many vehicles storing usage and repair data, a system operator can start to correlate the vehicle abuse/environment data to component failure and can better predict when the component should be inspected/replaced. Therefore, the collected sensor data and component data may be used to determine or modify an inspection and/or maintenance schedule. A system operator can also work with fleets when they are buying and specifying a new vehicle to have the fleet operator identify their expected usage profile. Collected sensor data and component data can be combined and analyzed by a predictive toolset to suggest optimal components that are best suited for a particular expected usage profile. For example, collected sensor data and component data may be used to identify that one particular type of landing gear has better corrosion resistance than another type. Such information may be helpful for future planning. For example, a fleet operating in high-corrosion environments, such as regions where salt is regularly used on roads for ice mitigation, may prefer to know about and use the type of landing gear with better corrosion resistance.

Wireless sensors of the present disclosure may be configured to use Periodic Advertising with Response (PAwR) feature of the BT 5.4 specification in order to improve range. PAwR is commonly used in Electronic Shelf Labels, to enable hundreds of BT labels in a store. PAwR may be implemented in on-vehicle wireless transmitters of the sensors, which may still be operated as a beacon. Additionally or alternatively, the wireless sensors may change timing, such as using random delays, to avoid collisions. The wireless sensors of the present disclosure may employ “adaptive” power management—if not getting through, transmitting power may be increased. If transmissions are always received, transmitting power may be decreased.

The wireless sensors of the present disclosure may use low energy (LE) Coded/Long Range physical layer (PHY) feature of the BT 5.0 and later specification. This feature may increase range by extending transmission. This feature may be combined with PAwR, making the wireless sensors of the present disclosure be “adaptive.” In some cases, the wireless sensors may recognize a sensor that is not successfully being received, and then increase sensor transmit power to improve success.

The present disclosure provides a bonded/paired beacon concept for a system that has several objectives. Objectives include: reducing sensor BT communication collision risk by assigning transmission timing to each sensor on a vehicle; reducing mobile device+App scanning overhead by only maintaining a bond or pairing to gateway (instead of all sensors); and minimizing sensor SKUs: with assigning functionality, no need to sell+inventory sensors of each type (TPMS, SPMS, iPlug, Door, Temp etc.)—only need Cap or Thru SKUs.

The bonded/paired beacon concept for a system may include initializing sensors and gateway devices for a given vehicle. The bonded/paired beacon concept may include the following major components or steps: initialize—the app. bonds or pairs to sensors to command function and timing; the app. may also bond or pair to a gateway. Once the sensors are confirmed, the app. may command the sensors to be 1-way beacons and assigns them to a gateway. The app. then assigns vehicle info to the gateway. If the vehicle is defined as a trailer, the mobile device disconnects. A truck gateway may be configured to look for trailer gateways and will notify the mobile app. if other trailers are seen. A driver/user can select which trailer they are hitching to. Operate: the app. may then stay bonded or paired to the truck gateway, receiving sensor info through the truck gateway. New users can bond or pair to the gateway to access vehicle info. If a trailer is assigned in the app., the truck gateway may bond or pair with the trailer gateway and route trailer data through to the app.

The system, methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above, and combinations thereof may be embodied in computer executable code that, when executing on one or more computing devices performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A wireless sensor system for a vehicle, comprising:
a given wireless sensor configured to monitor a corresponding physical parameter; and
a mobile device configured to communicate bidirectionally with the given wireless sensor for setting configuration data of the given wireless sensor,
wherein the mobile device is further configured to cause the given wireless sensor to operate in a 1-way communication mode and to periodically transmit sensor data regarding the corresponding physical parameter.

2. The wireless sensor system of claim 1, further including a gateway configured to receive the sensor data from a plurality of wireless sensors including the given wireless sensor.

3. The wireless sensor system of claim 2, wherein the gateway is configured to relay the sensor data from the plurality of wireless sensors to the mobile device.

4. The wireless sensor system of claim 2, wherein the gateway further includes at least one of a radio modem or cellular data radio, and which is configured to transmit the sensor data from the plurality of wireless sensors to a remote computer.

5. The wireless sensor system of claim 2, further including a second gateway, and wherein the gateway is configured to transmit the sensor data from the plurality of wireless sensors to the second gateway.

6. The wireless sensor system of claim 2, further including a sensor integrated with the gateway and configured to detect proximity to a magnet or metallic structure relative thereto.

7. The wireless sensor system of claim 2, further including a proximity sensor in functional communication with the gateway and configured to detect a position of at least one of: a brake actuator, a cargo rigging device, a landing gear, a bogie slider, a fifth wheel lock, or a deployable aerodynamic surface.

8. The wireless sensor system of claim 1, wherein the given wireless sensor includes a tire pressure monitoring sensor (TPMS).

9. The wireless sensor system of claim 1, wherein the given wireless sensor includes at least one of: a suspension air pressure sensor, a hub temperature sensor, a hub vibration sensor, a strap tension monitoring sensor, a door position sensor, or a proximity sensor.

10. The wireless sensor system of claim 1, wherein the given wireless sensor includes a temperature sensor configured to sense temperature of cargo.

11. The wireless sensor system of claim 1, wherein the given wireless sensor includes one or more accelerometers configured to detect a tension of a rigging device for securing cargo.

12. The wireless sensor system of claim 1, wherein the configuration data includes a timing period or a timing window for transmitting the sensor data.

13. The wireless sensor system of claim 1, wherein the configuration data includes a power setting for transmitting the sensor data.

14. A method of configuring a wireless sensor system for a vehicle, comprising:
sensing, by a mobile device, a new wireless sensor; and
transmitting, by the mobile device, configuration data to the new wireless sensor, wherein the configuration data causes the new wireless sensor to operate in a 1-way communication mode and to transmit sensor data to a gateway.

15. The method of claim 14, wherein sensing the new wireless sensor includes optically reading a quick response (QR) code attached to the new wireless sensor.

16. The method of claim 14, further comprising prompting, by a user interface of the mobile device, for an operator to designate a location on the vehicle for the new wireless sensor.

17. The method of claim 14, wherein the configuration data includes at least one of: a timing period for transmitting the sensor data, a timing window for transmitting the sensor data, or a power setting for transmitting the sensor data.

18. The method of claim 14, wherein the configuration data includes a first timing period for transmitting the sensor data, and a second timing period for transmitting alert messages, wherein the second timing period is substantially shorter than the first timing period.

19. A wireless sensor system for a truck and trailer, comprising:
a telemetry device;
a first plurality of wireless sensors and a first gateway each located on the truck, wherein the first plurality of wireless sensors are each configured to monitor a corresponding first physical parameter and to transmit a first sensor data regarding the corresponding first physical parameter, wherein the first gateway is configured to receive the first sensor data from the first plurality of wireless sensors and to relay the first sensor data to the telemetry device for transmission to a remote computer away from the truck and trailer; and
a second plurality of wireless sensors and a second gateway electronic module each located on the trailer, wherein the second plurality of wireless sensors are each configured to monitor a corresponding second physical parameter and to transmit a second sensor data regarding the corresponding second physical parameter, wherein the second gateway is configured to receive second sensor data from the second plurality of wireless sensors and to relay the second sensor data to the first gateway, and
wherein the first gateway is further configured to receive the second sensor data from the second gateway and to relay the second sensor data to the telemetry device for transmission to the remote computer.

20. The wireless sensor system of claim 19, wherein at least one wireless sensor of the first plurality of wireless sensors is configured to measure a first acceleration of at least one wheel of the truck,
wherein at least one wireless sensor of the second plurality of wireless sensors is configured to measure a second acceleration of at least one wheel of the trailer,
wherein at least one of the first gateway or the second gateway is configured to compare data regarding the first acceleration with data regarding the second acceleration to confirm that the trailer is coupled to the truck to move together, and
wherein the at least one of the first gateway or the second gateway is configured to confirm a bonding or pairing between the first gateway and the second gateway based on the confirmation that the trailer is coupled to the truck to move together.

21. The wireless sensor system of claim 19, wherein the first gateway includes a first accelerometer configured to measure a first acceleration of the truck,
wherein the second gateway includes a second accelerometer configured to measure a second acceleration of the trailer,
wherein at least one of the first gateway or the second gateway is configured to compare data regarding the first acceleration with data regarding the second acceleration to confirm that the trailer is coupled to the truck to move together, and
wherein the at least one of the first gateway or the second gateway is configured to confirm a bonding or pairing between the first gateway and the second gateway based on the confirmation that the trailer is coupled to the truck to move together.
